(19) United States
(12) Patent Application Publication
(10) Pub. No.: US 2013/0238326 A1
(43) Pub. Date: Sep. 12, 2013

(54) APPARATUS AND METHOD FOR MULTIPLE DEVICE VOICE CONTROL

(71) Applicants: Yongsin KIM, Seoul (KR); Dami CHOE, Seoul (KR); Hyorim PARK, Seoul (KR)

(72) Inventors: Yongsin KIM, Seoul (KR); Dami CHOE, Seoul (KR); Hyorim PARK, Seoul (KR)

(73) Assignee: LG ELECTRONICS INC., Seoul (KR)

(21) Appl. No.: 13/415,312

(22) Filed: Mar. 8, 2012

(51) Int. Cl. G10L 15/00

(52) U.S. Cl. 704/231; 704/E15.001

(57) ABSTRACT

In an environment including multiple electronic devices that are each capable of being controlled by a user's voice command, an individual device is able to distinguish a voice command intended particularly for the device from among other voice commands that are intended for other devices present in the common environment. The device is able to accomplish this distinction by identifying unique attributes belonging to the device itself from within a user's voice command. Thus only voice commands that include attribute information that are supported by the device will be recognized by the device, and other voice commands that include attribute information that are not supported by the device may be effectively ignored for voice control purposes of the device.

### BACKGROUND OF THE INVENTION

As advancements in technology have allowed communication between electronic devices to become easier and more secure, it has followed that many consumers have taken advantage by connecting their many consumer electronics devices to a common local home network. A local home network may be comprised of a personal computer (PC), television, printer, laptop computer and cell phone. While the set up of a common local home network offers many advantages for sharing information between devices, placing so many electronics devices together in a relatively small space presents some unique issues when it comes to controlling each individual device.

This becomes especially apparent when a user wishes to control multiple devices that are within close proximity to each other by a user's voice command. If multiple devices that are capable of receiving voice commands are situated within a listening distance from a common voice command source, when the common voice command source announces a voice command intended for a first device it may be difficult for the multiple devices to distinguish which device the voice command was actually intended for.

In some cases, a common voice command source may announce a voice command that actually includes multiple commands intended for the control of multiple devices. Such a voice command may be made in the form of a single natural language voice command sentence that includes a plurality of separate voice commands intended for a plurality of separate devices.

In both cases, when it comes to utilizing voice recognition and voice commands in a multi voice recognition capable device environment, there is an issue of how to ensure a voice command is received and understood by the intended device from among the multitude of voice recognition capable devices.

It follows that there is a need to provide an accurate voice recognition method to be used in such a multi voice recognition device environment.

### SUMMARY OF THE INVENTION

Accordingly, the present invention is directed to a device that is able to accurately recognize a voice command that is intended for the device from among other voice commands that are intended for other devices.

The present invention is also directed to a method for accurately recognizing a voice command that is intended for a given device from among other devices that are capable of receiving a voice command. Therefore it is an object of the present invention to substantially resolve the limitations and deficiencies of the related art when it comes to providing an accurate and efficient voice recognition device and method for user in a multi device environment.

To achieve this objective of the present invention, an aspect is directed to a method of recognizing a voice command by a device, the method comprising: receiving a voice input; processing the voice input by a voice recognition unit, and identifying at least a first voice command as including attribute information corresponding to the device from the voice input; recognizing the first voice command as being intended for the device based on at least the attribute information corresponding to the device identified from the first voice command, and controlling the device according to the recognized first voice command.

Preferably, the voice input is additionally comprised of at least a second voice command for controlling at least one other device.

More preferably, recognizing the first voice command further comprises: comparing the identified attribute information of the device against a list of device attributes that are available for voice command control, and recognizing the first voice command as being intended for the device when the attribute information of the device is identified as one of the device attributes that are available for voice command control.

Preferably, the device attributes that are available for voice command control include at least one of a display adjusting feature, volume adjusting feature, data transmission feature, data storage feature and internet connection feature.

More preferably, recognizing the first voice command further comprises: comparing the identified attribute information of the device against a list of preset voice commands that are stored on a storage unit of the device, and recognizing the first voice command as being intended for the device when the attribute information of the device is identified as one of the preset voice commands that are included in the list of preset voice commands.

More preferably, recognizing the first voice command further comprises: comparing the attribute information of the device against a list of attributes of the device that are currently being utilized by an application running on the device, and recognizing the first voice command as being intended for the device when the attribute information of the device is identified as one of the device attributes that are currently being utilized by an application running on the device.

Further in order to achieve the objectives of the present invention, another aspect of the present invention is directed to a device for recognizing a voice command, the device comprising: a microphone configured to receive a voice input; a voice recognition unit configured to process the voice input, identify at least a first voice command including an attribute information of the device from the voice input, and recognize the first voice command as being intended for the device based on at least the attribute information of the device identified from the first voice command, and a controller configured to control the device according to the recognized first voice command.

Preferably, the voice input is additionally comprised of at least a second voice command including attribute information for controlling at least one other device.

More preferably, the voice recognition unit is further configured to compare the identified attribute information of the device against a list of device attributes that are available for voice command control, and recognize the first voice command as being intended for the device when the attribute information of the device is identified as one of the device attributes that are available for voice command control.

Preferably, the device attributes that are available for voice command control include at least one of a display adjusting feature, volume adjusting feature, data transmission feature, data storage feature and internet connection feature.

More preferably, the voice recognition unit is further configured to compare the identified attribute information of the device against a list of preset voice commands that are stored on a storage unit of the device, and recognize the first voice command as being intended for the device when the attribute information of the device is identified as one of the preset voice commands that are included in the list of preset voice commands.

More preferably, the voice recognition unit is further configured to compare the attribute information of the device against a list of attributes of the device that are currently being utilized by an application running on the device, and recognize the first voice command as being intended for the device when the attribute information of the device is identified as one of the device attributes that are currently being utilized by an application running on the device.

Further in order to achieve the objectives of the present invention, another aspect of the present invention is directed to a method of recognizing a voice command by a device, the method comprising: receiving a voice input including at least a first voice command and a second voice command; processing the voice input by a voice recognition unit, and identifying the first voice command as including attribute information corresponding to the device and also identifying the second voice command as including attribute information that does not correspond to the device; recognizing the first voice command as being intended for the device based on at least the attribute information of the device identified from the first voice command, and controlling the device according to the recognized first voice command.

Preferably, the device is connected to a local network that includes at least a second voice recognition capable device.

More preferably, the method further comprises: transmitting information to the second voice recognition capable device identifying the device has been controlled according to the first voice command, and displaying information identifying the device has been controlled according to the first voice command.

More preferably, the method further comprises: transmitting information to a second voice recognition capable device identifying the device has not been controlled according to the second voice command.

More preferably, the method further comprises: receiving information from a second voice recognition capable device identifying the second voice recognition capable device has been controlled according to the second voice command, and displaying information identifying the second voice recognition capable device has been controlled according to the second voice command.

More preferably, the method further comprises: displaying information identifying the device has been controlled according to the first voice command.

More preferably, the method further comprises: displaying information identifying the device has been controlled according to the first voice command.

Further objects, features and advantages of the present invention will become apparent from the detailed description that follows. It is to be understood that both the foregoing general description and the following detailed description of the present invention are exemplary and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram for a voice recognition capable device, according to the present invention;

FIG. 2 illustrates a home network including a plurality of voice recognition capable devices, according to the present invention;

FIG. 3 illustrates a flow chart describing a method for voice recognition, according to some embodiment of the present invention;

FIG. 4 illustrates a flow chart describing a method for voice recognition, according to some embodiment of the present invention;

FIG. 5 illustrates a flow chart describing a method for voice recognition, according to some embodiment of the present invention;

FIG. 6 illustrates a flow chart describing a method for voice recognition, according to some embodiment of the present invention;

FIG. 7 illustrates a results chart that may be displayed, according to some embodiments of the present invention;

FIG. 8 illustrates a flow chart describing a method for voice recognition, according to some embodiments of the present invention;

FIG. 9 illustrates a flow chart describing a method for voice recognition, according to some embodiments of the present invention.

### DETAILED DESCRIPTION OF THE INVENTION

Reference will now be made in detail to exemplary embodiments of the present invention, examples of which are illustrated in the accompanying drawings. It will be apparent to one of ordinary skill in the art that in certain instances of the following description, the present invention is described without the specific details of conventional details in order to avoid unnecessarily distracting from the present invention. Wherever possible, like reference designations will be used throughout the drawings to refer to the same or similar parts. All mention of a voice recognition capable device is to be understood as being made to a voice recognition capable device of the present invention unless specifically described otherwise.

It will be apparent to those skilled in the art that various modifications and variations can be made in the present invention. Thus, although the foregoing description has been described with reference to specific examples and embodiments, these are not intended to be exhaustive or to limit the invention to only those examples and embodiments specifically described.

It follows that the present invention is able to provide accurate voice command recognition for allowing an individual voice recognition capable device to distinguish a specific voice command intended for the individual voice recognition capable device from among a plurality of other voice commands intended for a plurality of other voice recognition capable devices. The individual voice recognition capable device may be one voice recognition capable device that is situated within a close proximity to other voice recognition capable devices. In some embodiments, the plurality of voice recognition capable devices may be connected to form a common local network or home network. In other embodiments, an individual voice recognition capable device need not specifically be connected to other devices via a common network, but rather the individual voice recognition capable device may simply be one of a multitude of voice recognition capable devices that are situated within a relatively small area such that the multitude of voice recognition capable devices are able to hear a user's announced voice commands.

In either case, the common issue that arises when you have a multitude of voice recognition capable devices placed within close proximity to each other is that a user's voice command intended for a first voice recognition capable device is heard by the other voice recognition capable devices that are in close proximity. This makes it difficult from the standpoint of the first voice recognition capable device to understand which of the user's voice command was truly intended for the first voice recognition capable device.

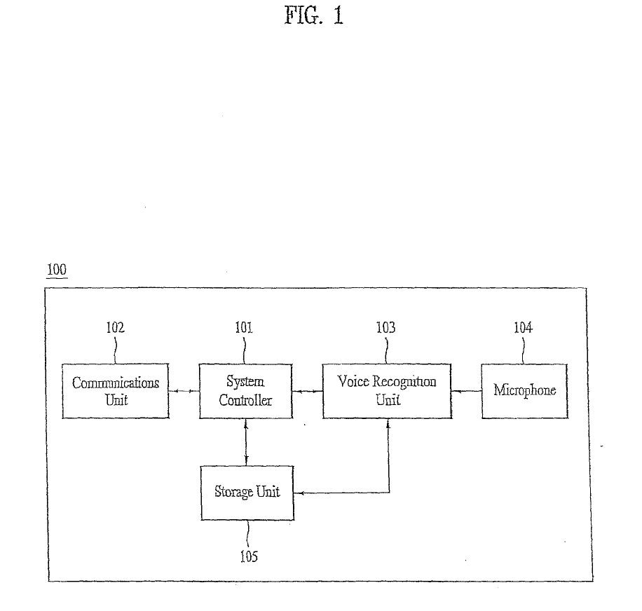

To provide a solution to this issue and in order to provide a more accurate voice recognition process, FIG. 1 illustrates a general architecture block diagram for a voice recognition capable device 100 according to the present invention. The voice recognition capable device 100 illustrated by FIG. 1 is provided as an exemplary embodiment, but it is to be appreciated that the present invention may be implemented by a voice recognition capable devices that may include a fewer, or greater, number of components than what is expressly illustrated in FIG. 1. The voice recognition capable device 100 illustrated in FIG. 1 is preferably a television set, but alternatively the voice recognition capable device 100 may, for example, be any one of a mobile telecommunications device, notebook computer, personal computer, tablet computing device, portable navigation device, portable video player, personal digital assistant (PDA) or other similar device that is able to implement voice recognition.

The voice recognition capable device 100 includes a system controller 101, communications unit 102, voice recognition unit 103, microphone 104 and a storage unit 105. Although not all specifically illustrated in FIG. 1, components of the voice recognition capable device 100 are able to communicate with each other via one or more communication buses or signal lines. It should also be appreciated that the components of the voice recognition capable device 100 may be implemented as hardware, software, or a combination of both hardware and software (e.g. middleware).

The communications unit 102, as illustrated in FIG. 1, may include RF circuitry that allows for wireless access to outside communications networks such as the Internet, Local Area Networks (LANs), Wide Area Networks (WANs) and the like. The wireless communications networks accessed by the communications unit 102 may follow various communications standards and protocols including, but not limited to, Global System for Mobile Communications (GSM), Enhanced Data GSM Environment (EDGE), code division multiple access (CDMA), wideband code division multiple access (W-CDMA), time division multiple access (TDMA), Bluetooth, Wireless Fidelity (Wi-Fi), Short Message Service (SMS) text messaging and any other relevant communications standard or protocol that allows for wireless communication by the device voice recognition capable 100. In some embodiments of the present invention, the communications unit 102 may also include a tuner for receiving broadcasting signal from either a terrestrial broadcast source, cable headend source or internet source.

Additionally, the communications unit 102 may include various input and output interfaces (not expressly shown) for allowing wired data transfer communication between the voice recognition capable device 100 and external electronics devices. The interfaces may include, for example, interfaces that allow for data transfers according to the family of universal serial bus (USB) standards, the family of IEEE 1394 standards or other similar standards that relate to data transfer.

The system controller 101, in conjunction with data and instructions stored on the storage unit 105, will control the overall operation of the voice recognition capable device 100. In this way, the system controller 101 is capable of controlling all of the components, both as illustrated in FIG. 1 and those not specifically illustrated, of the voice recognition capable device 100. The storage unit 105 as illustrated in FIG. 1 may include non-volatile type memory such as non-volatile random-access memory (NVRAM) or electrically erasable programmable read-only memory (EEPROM), commonly referred to as flash memory. The storage unit 105 may also include other forms of high speed random access memory such as dynamic random-access memory (DRAM) and static random-access memory (SRAM), or may include a magnetic hard disk drive (HDD). In cases where the device is a mobile device, the storage unit 105 may additionally include a subscriber identity module (SIM) card for storing a user's profile information. The storage unit 105 may store a list of preset voice commands that are available for controlling the voice recognition capable device 100.

The microphone 104 is utilized by the voice recognition capable device 100 to pick up audio signals (e.g. user's voice input) that are made within the environment surrounding the voice recognition capable device 100. With respect to the present invention, the microphone 104 serves to pick up a user's voice input announced to the voice recognition capable device 100. The microphone 104 may constantly be in an ‘on’ state to ensure that a user's voice input may be received at all times. Even when the voice recognition capable device 100 is in an ‘off’ state, the microphone 104 may be kept on in order to allow for the voice recognition capable device 100 to be turned on with a user's voice input command. In other embodiments, the microphone may be required to be turned ‘on’ during a voice recognition mode of the voice recognition capable device 100.

The voice recognition unit 103 receives a user's voice input that is picked up by the microphone 104 and performs a voice recognition process on the audio data corresponding to the user's voice input in order to interpret the meaning of the user's voice input. The voice recognition unit 103 may then perform processing on the interpreted voice input to determine whether the voice input included a voice command intended to control a feature of the voice recognition capable device 100. A more detailed description for the voice recognition processing accomplished by the voice recognition unit 103 will be provided throughout this disclosure.

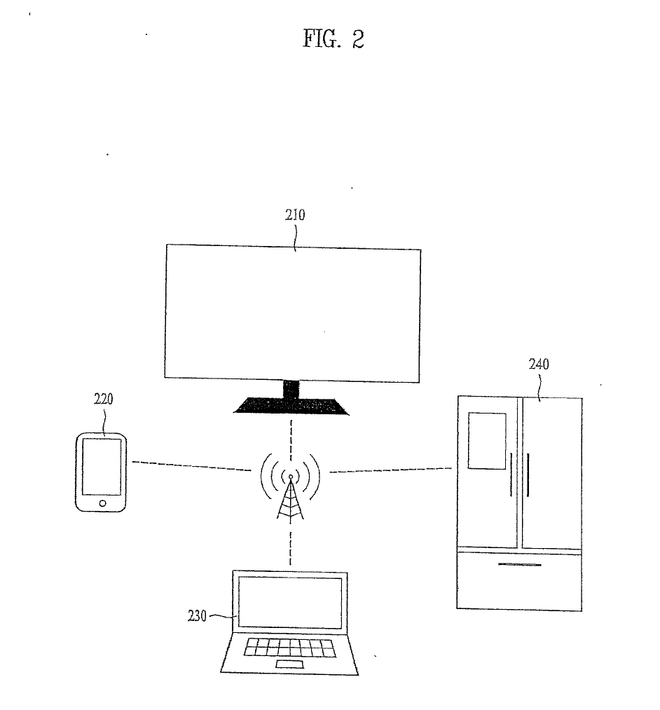

FIG. 2 illustrates a scene according to some embodiments of the present invention where a plurality of voice recognition capable devices are connected to form a common home network. The scene illustrated in FIG. 2 is depicted to include a television 210, mobile communication device 220, laptop computer 230 and a refrigerator 240. Also, the block diagram for the voice recognition capable device 100 described in FIG. 1 may be embodied by any one of the television 210, mobile display device 220, laptop computer 230 and the refrigerator 240 depicted in FIG. 2. It should be understood that the voice recognition capable devices depicted in the home network illustrated in FIG. 2 are made for exemplary purposes only as the present voice recognition invention may be utilized in a home network that includes fewer or more devices.

In a situation where a plurality of voice recognition capable devices are placed in relatively close proximity, such as the home network described in FIG. 2, there arises the issue of how to effectively utilize voice commands to control each individual voice recognition capable device. When there is only a single device capable of voice recognition, only the single voice recognition capable device is required to receive a user's voice command and perform voice recognition processing on the voice command to determine the user's control intention. However, when multiple voice recognition capable devices are placed in a relatively small area within a hearing distance from each other, a user's voice command may be picked up by all of the voice recognition capable devices and it becomes difficult for the individual voice recognition capable devices to accurately determine which voice recognition capable device was intended to receive the user's voice command to be controlled by the user's voice command.

To address this issue, the present invention offers a method for accurately performing voice recognition by a voice recognition capable device that is situated amongst other voice recognition capable devices. The present invention is able to accomplish this by taking into account the unique attributes that are available on each individual voice recognition capable device. An attribute of a voice recognition capable device may relate to a functional capability of the voice recognition capable device that is available for controlling by a voice command. For instance an attribute may be any one of a display adjusting feature, volume adjusting feature, data transmission feature, data storage feature and internet connection feature.

The following provides an example where a volume setting feature may be an attribute that is supported to be controlled by a voice command, for example, on a voice recognition capable device. When a user announces a voice command for controlling a volume setting in the presence of the television 210, mobile communication device 220, laptop computer 230 and refrigerator 240 in the environment illustrated by FIG. 2, each of these voice recognition capable devices may receive/hear the user's voice command. Then the voice recognition unit 103 for each respective voice recognition capable device will process the user's voice command and identify the volume feature as the attribute included in the voice command. After identifying the volume feature as the attribute that is intended to be controlled by the user's voice command, only the television 210, mobile communication device 220, laptop computer 230 may actually recognize the voice command as potentially being intended for it because only these voice recognition capable devices are capable of supporting a volume setting attribute. This is because the television 210, mobile communication device 220, laptop computer 230 inherently support a volume setting feature. Because the refrigerator 240 (in most cases) is not capable of supporting the volume setting attribute, the refrigerator 240 may hear the user's volume setting voice command but it will not recognize the volume setting voice command as intended for it after identifying the volume setting as the attribute from the user's voice command.

To narrow things even further, in some embodiments of the present invention, a voice recognition capable device may not recognize a user's voice command if the attribute identified from the user's voice command is not currently being utilized by the voice recognition capable device. This is true even if the voice recognition capable device inherently supports such an attribute. For instance, if the mobile communication device 220 and the laptop computer 230 are not specifically running an application that requires a volume setting when the user's volume setting voice command is announced, then if the television 210 is currently displaying a program, then the television 210 may be the only device from amongst the plurality of devices to recognize the volume setting voice command and perform a volume setting control in response to the user's volume change voice command. This additional layer of smart processing offered by the present invention provides a more accurate prediction of determining the true intention of a user's voice command.

Or in other embodiments, the attribute may simply refer to a specific voice command that is preset to be stored within a list of preset voice commands on a voice recognition capable device. Each voice recognition capable device may store a list of preset voice commands, where the preset voice commands relate to functional capabilities that are supported by the particular voice recognition capable device. For instance a temperature setting voice command may only be included in a list of preset voice commands found on a refrigerator device and would not be found on a list of preset voice commands for a laptop computer device. Referring to the scene depicted in FIG. 2, this means that when a user announces a voice command involving the change of a temperature setting in the presence of the television 210, mobile communication device 220, the laptop computer 230 and the refrigerator 240, only the refrigerator 240 will recognize the temperature setting voice command as it would be the only voice recognition capable device that has a preset voice command for changing a temperature setting stored within a list of preset voice commands. The other voice recognition capable devices do not support a temperature setting feature and so it is foreseeable that they will not store a preset voice command for changing a temperature setting.

Although the preceding description has described the plurality of voice recognition capable devices being connected to a common local network, not all embodiments of the present invention requires the plurality of voice recognition capable devices to be specifically connected to a common local network. Instead, according to alternative embodiments, a voice recognition capable device of the present invention may be utilized as a stand alone device that is simply in an environment where it is in relatively close proximity to other voice recognition capable devices.

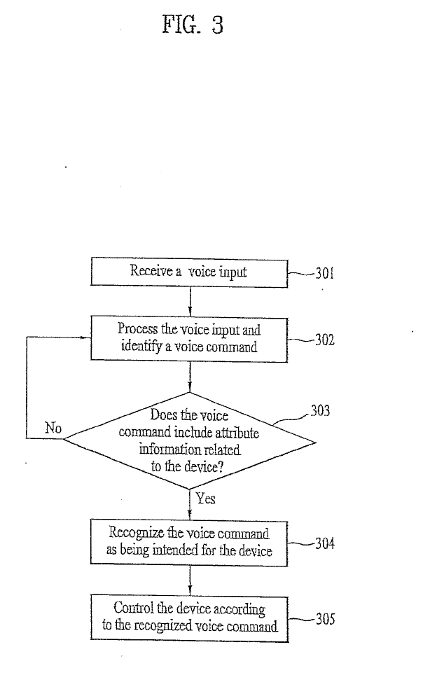

FIG. 3 offers a flow chart describing the steps involved in a voice recognition process according to the present invention. It should be assumed that the flow chart is described from the viewpoint of a voice recognition capable device that includes at least the components as illustrated in FIG. 1. At step 301a user announces a voice input in the presence of a voice recognition capable device, and the voice input is received by the voice recognition capable device. The reception of the user's voice input by the voice recognition capable device may be accomplished by the microphone 104. It should be understood that the voice input includes at least one voice command intended to be recognized by the voice recognition capable device for controlling a feature of the voice recognition capable device. However the voice input may additionally include other voice commands intended for other voice recognition capable devices that are within a relatively close proximity to the device. For example the user's voice input may be, “volume up and temperature down”. This example of a user's voice input actually includes two separate voice commands. The first voice command refers to a “volume up” voice command, and the second voice command refers to a “temperature down” command. The user's voice input may also include superfluous natural language vocabulary that are not part of any recognizable voice command.

At step 302 the voice recognition capable device will have received the user's voice input and will proceed to process the voice input to identify at least the first voice command from within the user's voice input. This processing step 302 is important to extract a proper voice command from out of the user's voice input, where the user's voice input may be comprised of additional voice commands and natural language words in addition to the first voice command. Processing and identifying a voice command from the user's voice input may be accomplished by the voice recognition unit 103.

At step 303, the voice recognition unit 103 further makes a determination as to whether the identified voice command includes attribute information that is related to the voice recognition capable device. If the voice recognition unit 103 determines that the identified voice command does contain attribute information related to the voice recognition capable device, the voice recognition capable device will recognize that the voice command was indeed intended for the voice recognition capable device at step 304. However in the case that the voice recognition unit 103 is not able to identify attribute information that is related to the voice recognition capable device from the voice command, then the process reverts back to step 302 to determine whether any additional voice commands can be found from within the user's voice input.

At step 304 the voice command is recognized as being intended for the voice recognition capable device, and then at step 305 the results of the recognized voice command will be sent to the voice recognition capable device's system controller 101, where the system controller 101 will control the voice recognition capable device according to the instructions identified from the recognized voice command.

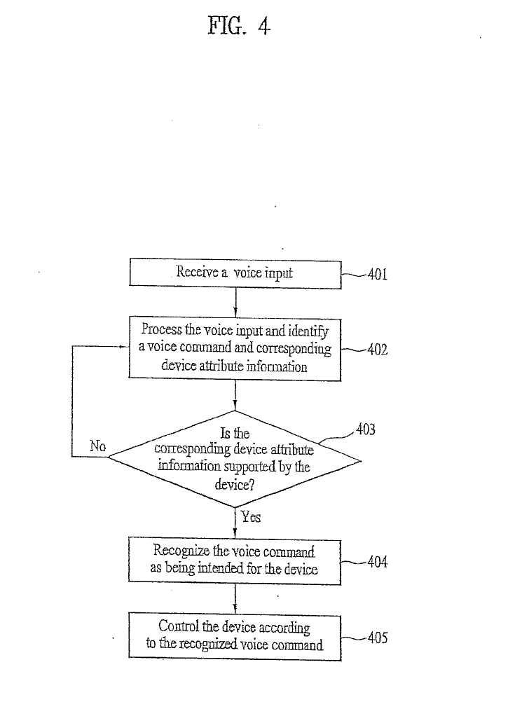

FIG. 4 is a flow chart that describes the steps involved with a voice recognition process according to the present invention. The flow chart of FIG. 4 is able to provide a more in depth description for analyzing the specific attribute of a voice recognition capable device when performing the voice recognition according to some embodiments of the present invention. At step 401a user announces a voice input in the presence of a voice recognition capable device, and the voice input is received by the voice recognition capable device. The reception of the user's voice input by the voice recognition capable device may be accomplished by the microphone 104 seen in FIG. 1. It should be understood that the voice input includes at least one voice command intended to be recognized by the device for controlling a feature of the voice recognition capable device. However the voice input may additionally include other voice commands intended for other voice recognition capable devices that are within a relatively close proximity to the device, as well as superfluous natural language vocabulary.

At step 402 the voice recognition capable device will have received the user's voice input and will proceed to process the voice input to identify at least a first voice command and corresponding device attribute information from within the user's voice input. The corresponding device attribute information is information that identifies a feature of the voice recognition capable device that is intended to be controlled by the user's voice command. This information can be extracted from the user's first voice command. For instance, if the user's first voice command were identified to be “volume up”, then the corresponding device attribute information will be identified as the volume feature that the user is attempting to control. Processing and identifying a voice command from the user's voice input may be accomplished by the voice recognition unit 103.

At step 403, a further determination is made as to whether the identified device attribute from the first voice command relates to a feature that is supported by the voice recognition capable device. Using the same example of when the user's first voice command is, “volume up”, at step 403 the voice recognition capable device will then have to make a determination as to whether the volume setting feature is an attribute that is supported by the voice recognition capable device. This determination will vary depending on the voice recognition capable device. For instance a television device will support a volume setting feature, but a refrigerator device in most cases will not support such a volume setting feature. The actual processing of determining whether the identified device attribute is supported by the voice recognition capable device may be accomplished by either the voice recognition unit 103 or the system controller 101.

If it is determined at step 403 that the identified device attribute is an attribute that is supported by the voice recognition capable device, the voice recognition capable device will recognize that the voice command was indeed intended for the voice recognition capable device at step 404. However in the case that the identified device attribute is an attribute that is not supported by the voice recognition capable device, then the process reverts back to step 402 to determine whether any additional voice commands can be found from within the user's voice input.

At step 404 the voice command is recognized as being intended for the voice recognition capable device, and then at step 405 the results of the recognized voice command will be processed by the voice recognition capable device's system controller 101, where the system controller 101 will control the voice recognition capable device according to the instructions identified from the recognized voice command.

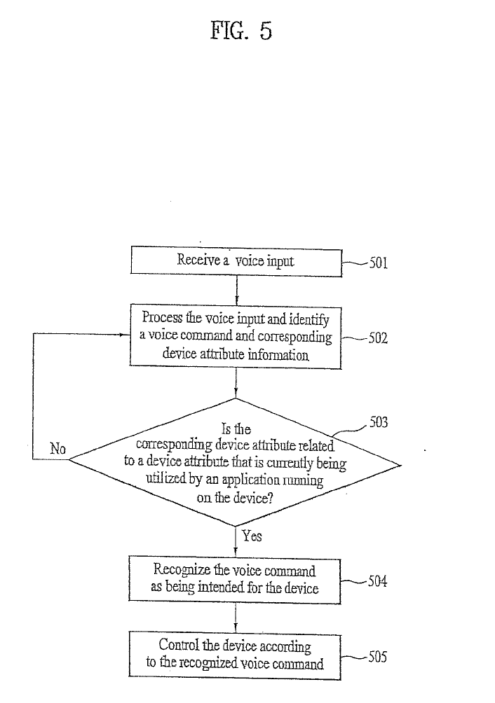

FIG. 5 is a flow chart that describes the steps involved with a voice recognition process according to the present invention. The flow chart of FIG. 5 is able to provide a more in depth description for analyzing the specific attribute of a voice recognition capable device when performing the voice recognition according to some embodiments of the present invention. At step 501a user announces a voice input in the presence of a voice recognition capable device, and the voice input is received by the voice recognition capable device. The reception of the user's voice input by the voice recognition capable device may be accomplished by the microphone 104 seen in FIG. 1. It should be understood that the voice input includes at least one voice command intended to be recognized by the device for controlling a feature of the device. However the voice input may additionally include other voice commands intended for other voice recognition capable devices that are within a relatively close proximity to the device, as well as superfluous natural language vocabulary.

At step 502 the voice recognition capable device will have received the user's voice input and will proceed to process the voice input to identify at least a first voice command and corresponding device attribute information from within the user's first voice command. The corresponding device attribute information is information that identifies a feature of the voice recognition capable device that is intended to be controlled by the user's voice command. This information can be extracted from the user's voice command. For instance, if a user's voice command were identified to be “volume up”, then the corresponding device attribute information will be identified as the volume feature that the user is attempting to control. Processing and identifying a voice command from the user's voice input may be accomplished by the voice recognition unit 103.

At step 503, a further determination is made as to whether the identified device attribute is related to a device attribute that is currently being utilized by an application running on the voice recognition capable device. Step 503 offers a more in depth analysis over similar step 403 offered in the process described by the flow chart of FIG. 4. Step 503 is made to account for the situation where a certain device attribute is natively available on a voice recognition capable device, but the current application being run on the voice recognition capable device is not utilizing the certain device attribute. For instance, a mobile communication device may inherently be capable of volume setting control as it will undoubtedly include speaker hardware for outputting audio. And such speaker hardware will be utilized, for instance, when running a music player application where volume setting control is required. However, if the same mobile communication device is currently running a book reading application, the volume setting control would not currently be utilized as only the display of words is required for such a book reading application. A book reading application thus does not utilize audio output. Therefore under such a situation, even though the mobile communication device is natively capable of volume setting control, a user's voice command for changing a volume setting is most likely not intended for the mobile communication device that is currently running a book reading application. Instead, the user's voice command for changing a volume setting would most likely be intended for another voice recognition capable device that is currently running an application that requires a volume setting control. Therefore, step 503 offers smarter voice recognition ability for a voice recognition capable device to not only determine whether a device attribute identified from a voice command is inherently supported by the voice recognition capable device, but to take it a step further and determine whether the voice recognition capable device is currently running an application that is utilizing the device attribute. The actual processing of determining whether the identified device attribute is supported by the voice recognition capable device may be accomplished by either the voice recognition unit 103 or the system controller 101.

If it is determined at step 503 that the identified device attribute is an attribute that is currently being utilized by an application that is running on the voice recognition capable device, the voice recognition capable device will recognize that the voice command was indeed intended for the voice recognition capable device at step 504. However in the case that the identified device attribute is an attribute that is not currently being utilized by an application running on the voice recognition capable device, then the process reverts back to step 502 to determine whether any additional voice commands can be found from within the user's voice input.

At step 504 the voice command is recognized as being intended for the voice recognition capable device, and then at step 505 the results of the recognized voice command will be processed by the voice recognition capable device's system controller 101, where the system controller 101 will control the voice recognition capable device according to the instructions identified from the recognized voice command.

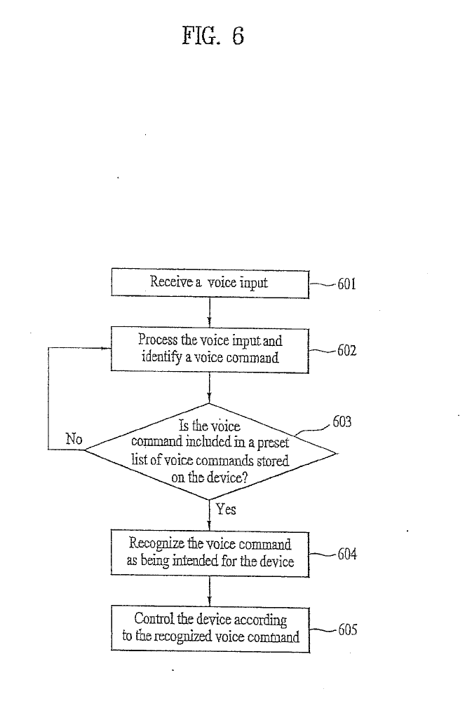

FIG. 6 is a flow chart that describes the steps involved with a voice recognition process according to the present invention. The flow chart of FIG. 6 is able to provide a more in depth description for analyzing the specific attribute of a voice recognition capable device when performing the voice recognition according to some embodiments of the present invention. At step 601a user announces a voice input in the presence of a voice recognition capable device, and the voice input is received by the voice recognition capable device. The reception of the user's voice input by the voice recognition capable device may be accomplished by the microphone 104 seen in FIG. 1. It should be understood that the voice input includes at least one voice command intended to be recognized by the device for controlling a feature of the device. However the voice input may additionally include other voice commands intended for other voice recognition capable devices that are within a relatively close proximity to the device, as well as superfluous natural language vocabulary.

At step 602 the voice recognition capable device will have received the user's voice input and will proceed to process the voice input to identify a voice command from within the user's voice input. The voice recognition unit 103 is responsible for processing the audio data that comprises the user's voice input and identifying the voice command from amongst all the words of the user's voice input. This is an important task as the user's voice input may be comprised of a plethora of other words besides the voice command. Some of the additional words may correspond to other voice commands intended for other voice recognition capable devices as mentioned above, and other words may simply be part of a user's natural language conversation. In any case, the voice recognition unit 103 is responsible for processing the user's voice input to identify the voice command from amongst the other audio data of the user's voice input.

At step 603, a further determination is made as to whether the identified voice command from step 602 matches up to a voice command that is part of a preset list of voice commands that is stored on the voice recognition capable device. The preset list of voice commands may be stored on the storage unit 105 on the voice recognition capable device. The preset list of voice commands will include voice commands for controlling a set of predetermined features of the voice recognition capable device. Thus by comparing the identified voice command that is extracted from the user's voice input against the voice commands that are part of the preset list of voice commands stored on the voice recognition capable device, the voice recognition capable device will be able to determine whether the voice recognition capable device is capable of handling the task identified in the identified voice command. The actual processing of determining whether the identified voice command matches up to a voice command included in a preset list of voice commands that is stored on the voice recognition capable device may be accomplished by either the voice recognition unit 103 or the system controller 101.

If it is determined at step 603 that the identified voice command matches up to a voice command included in a preset list of voice commands that is stored on the voice recognition capable device, the voice recognition capable device will recognize that the voice command was indeed intended for the voice recognition capable device at step 604. However in the case that the identified voice command does not match up to a voice command included in a preset list of voice commands that is stored on the voice recognition capable device, then the process reverts back to step 602 to determine whether any additional voice commands can be found from within the user's voice input.

At step 604 the voice command is recognized as being intended for the voice recognition capable device, and then at step 605 the results of the recognized voice command will be processed by the voice recognition capable device's system controller 101, where the system controller 101 will control the device according to the instructions identified from the recognized voice command.

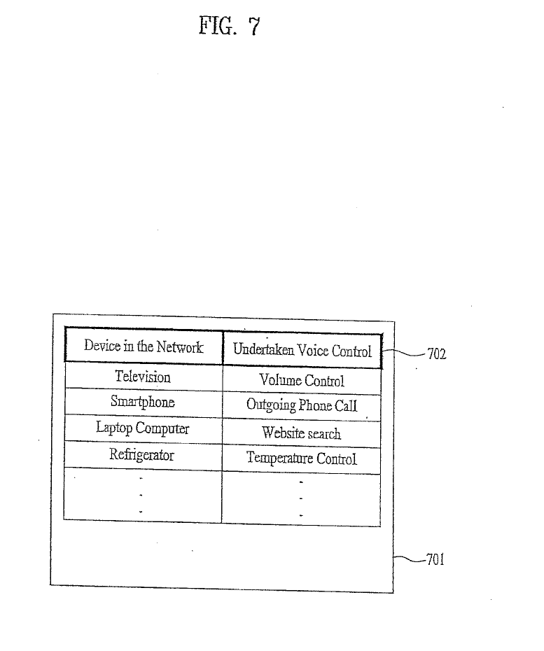

According to some embodiments of the present invention where a multitude of voice recognition capable devices are connected to a common home network, it may be desirable to display the results of how each voice recognition capable device recognized and handled a user's series of voice commands. For instance, after a user has announced a series of voice commands and the series of voice commands have been recognized by the intended target voice recognition capable device in a home network, one of the devices may be selected to display a chart describing the results as illustrated by FIG. 7. The voice recognition capable device that is selected to display the results of how a user's series of voice commands has been handled by the multitude of voice recognition capable devices in a home network may be any voice recognition capable device that offers a proper display screen. For example, any one of the television 210, mobile communication device 220 or laptop computer 230 described in the exemplary home network in FIG. 2 may be selected to display the results.

Specifically, a user may select a voice recognition capable device that includes a proper display screen to be designated as displaying the results of how a user's series of voice commands has been handled by the multitude of voice recognition capable devices in a home network. Or alternatively, one of the voice recognition capable devices (e.g. a television) within a home network may be designated as a main device of the home network, and therefore be predetermined to display the results of how a user's series of voice commands has been handled by the multitude of voice recognition capable devices in the home network.

FIG. 7 illustrates a results chart 702 being displayed on a display screen 701 of a voice recognition capable device that is part of a home network. The home network may be assumed to be the same as depicted in FIG. 2 that includes at least a television 210, mobile communication device 220, laptop computer 230 and refrigerator 240. The results chart 702 according to the present invention may be displayed on a voice recognition capable device after each of a user's voice commands have been handled by its intended voice recognition capable device in the home network.

So a user may first announce a series of voice commands within the home network environment, where each of the voice commands are received by each of the voice recognition capable devices within the common home network. After each of the voice recognition capable devices has received the user's voice commands, processed the user's voice commands as described throughout this description, and handled a control according to the results of the said processing, the results chart 702 may be created and displayed. The results chart 702 according to the present invention may include at least the name of each voice recognition capable device included in a common home network, and the resulting control undertaken by the respective voice recognition capable device in response to the user's announced voice commands. By providing such a visual representation that describes the results of how a user's series of voice commands have been handled by the individual voice recognition capable devices within a common home network, the user may be ensured that the proper voice recognition capable device recognized the proper voice command that was intended for it and undertook the proper control handling accordingly.

In order to more accurately determine which voice recognition capable device within a home network handled a particular control command corresponding to a user's voice command, it may be desirable to transmit information identifying which voice commands were recognized and handled by which voice recognition capable device, and also which voice commands were not recognized and handled by which voice recognition capable device in a common home network. For instance, in a home network environment where a plurality of voice recognition capable devices are able to hear a user's announced voice input, a first voice recognition capable device in the home network may hear the user's voice input and detect that it is comprised of a first voice command and a second voice command. Now assuming that only the first voice command was intended by the user to control the first voice recognition capable device, the first voice recognition capable device will only recognize the first voice command as intended for the first voice recognition capable device and handle a control command accordingly. Then, the first voice recognition capable device may transmit to other voice recognition capable devices in the home network, information identifying that the first voice recognition capable device was controlled according to the first voice command. Optionally, the first voice recognition capable device may also transmit to other voice recognition capable devices in the home network, information identifying that the first voice recognition capable device was not controlled according to the second voice command.

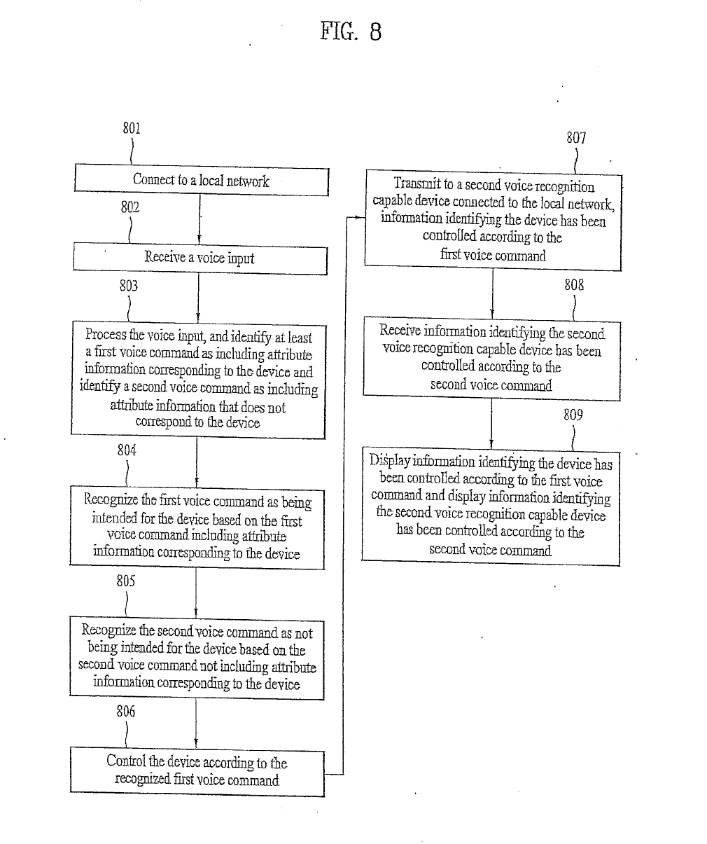

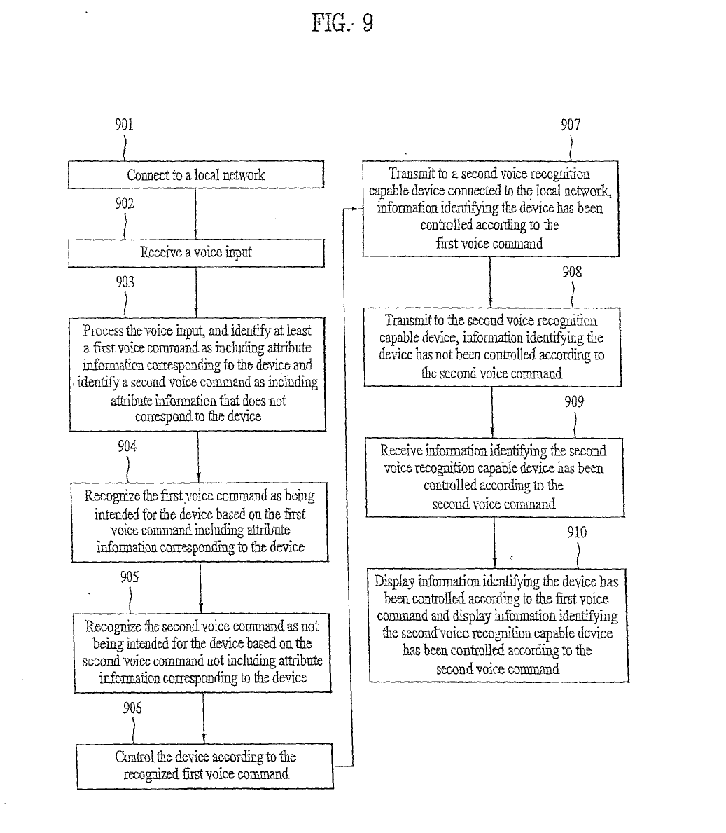

To better describe the process of transmitting and receiving information identifying which voice recognition capable device has handled a particular voice command, a description is provided according to some embodiments of the present invention by the flow charts illustrated in FIG. 8 and FIG. 9.

In FIG. 8, a voice recognition capable device will first connect to a local network in step 801. It may be presumed that the local network is comprised of at least the voice recognition capable device and one additional voice recognition capable device (e.g. a second voice recognition capable device).

Then in step 802 a user announces a voice input, and the voice recognition capable device will receive the user's voice input. It may also be assumed that the other voice recognition capable devices that comprise the local network have received the user's voice input, although in some alternative embodiments not all voice recognition capable devices within the local network may have received the user's voice input. It may also be assumed that the user's voice input is comprised of at least a first voice command and a second voice command.

Then in step 803 the voice recognition capable device will process the user's voice input, and identify at least the first voice command as including attribute information corresponding to the voice recognition capable device. The voice recognition capable device will also process the user's voice input, and identify at least the second voice command as including attribute information that does not correspond to the voice recognition capable device. A more detailed description for what constitutes a device attribute has been given above.

Then in step 804 the voice recognition capable device will recognize the first voice command as being intended for the voice recognition capable device based on the finding that the first voice command includes attribute information corresponding to the voice recognition capable device.

In a similar fashion, in step 805 the voice recognition capable device will recognize the second voice command as not being intended for the voice recognition capable device based on the finding that the attribute information identified from the second voice command does not correspond to the voice recognition capable device.

Then in step 806 the voice recognition capable device will handle a control function over itself according to the recognized first voice command that included attribute information corresponding to the voice recognition capable device.

Now after handling the control function over itself, in step 807 the voice recognition capable device will then transmit to at least the second voice recognition capable device, information identifying the voice recognition capable device has been controlled according to the first voice command. In some embodiments, the voice recognition capable device may transmit information identifying the voice recognition capable device has been controlled according to the first voice command to not just the second voice recognition capable device, but all other voice recognition capable devices connected to the common local network.

In step 808, the voice recognition capable device will also receive information identifying the second voice recognition capable device has been controlled according to the second voice command. It may be assumed that according to some embodiments, the voice recognition capable device receives this information from the second voice recognition capable device directly, while in other embodiments the voice recognition capable device receives this information from another device in the local network that is designated as a main device. In the embodiments where the voice recognition capable device receives this information from another device that is designated as a main device, the main device may be distinguished as being responsible for handling information from other devices that are connected to the local network. An example for a main device according to the present invention may be a television set that is capable of voice recognition. Another example for a main device according to the present invention may be a server device that is able to receive, store and transmit information/data from and to all devices that are connected to a local network.

Finally, in step 809 the voice recognition capable device will display information identifying that the voice recognition capable device has been controlled according to the first voice command, and also display information identifying the second voice recognition capable device has been controlled according to the second voice command. According to these embodiments of the present invention, the voice recognition capable device is able to display such information because it is assumed that the voice recognition capable device is one with a proper display screen.

According to the flow chart depicted in FIG. 9, most all of the steps mirror those already described for the flow chart depicted by FIG. 8. However, the flow chart depicted in FIG. 9 describes the additional step 908 that may be included according to some embodiments of the present invention. The step 908 additionally adds the process of transmitting to the second voice recognition capable device, information identifying that the voice recognition capable device has not been controlled according to the second voice command. In some embodiments, this information may additionally be transmitted to all other voice recognition capable devices connected to the common local network and not just to the second voice recognition capable device.

Thus in addition to transmitting only the information identifying that the voice recognition capable device has been controlled according to the first voice command (as described with reference to the flow chart of FIG. 8), the process described by the flow chart of FIG. 9 additionally adds the transmission of information identifying that the voice recognition capable device has not been controlled according to the second voice command. This added step 908 provides an additional layer of information for describing how each of a plurality of a user's voice commands have been handled by each of a plurality of voice recognition capable devices connected to a common local network.

It will be apparent to those skilled in the art that various modifications and variations can be made in the present invention. Thus, although the foregoing description has been described with reference to specific examples and embodiments, these are not intended to be exhaustive or to limit the invention to only those examples and embodiments specifically described.

What is claimed is:

1. A method of recognizing a voice command by a device, the method comprising:
receiving a voice input;
processing the voice input by a voice recognition unit, and identifying at least a first voice command as including attribute information corresponding to the device from the voice input;
recognizing the first voice command as being intended for the device based on at least the attribute information corresponding to the device identified from the first voice command, and
controlling the device according to the recognized first voice command.

2. The method of claim 1, wherein the voice input is additionally comprised of at least a second voice command for controlling at least one other device.

3. The method of claim 1, wherein recognizing the first voice command further comprises:
comparing the identified attribute information of the device against a list of device attributes that are available for voice command control, and
recognizing the first voice command as being intended for the device when the attribute information of the device is identified as one of the device attributes that are available for voice command control.

4. The method of claim 3, wherein the device attributes that are available for voice command control include at least one of a display adjusting feature, volume adjusting feature, data transmission feature, data storage feature and internet connection feature.

5. The method of claim 1, wherein recognizing the first voice command further comprises:
comparing the identified attribute information of the device against a list of preset voice commands that are stored on a storage unit of the device, and
recognizing the first voice command as being intended for the device when the attribute information of the device is identified as one of the preset voice commands that are included in the list of preset voice commands.

6. The method of claim 1, wherein recognizing the first voice command further comprises:
comparing the attribute information of the device against a list of attributes of the device that are currently being utilized by an application running on the device, and
recognizing the first voice command as being intended for the device when the attribute information of the device is identified as one of the device attributes that are currently being utilized by an application running on the device.

7. A device for recognizing a voice command, the device comprising:
a microphone configured to receive a voice input;
a voice recognition unit configured to process the voice input, identify at least a first voice command including an attribute information of the device from the voice input, and recognize the first voice command as being intended for the device based on at least the attribute information of the device identified from the first voice command, and
a controller configured to control the device according to the recognized first voice command.

8. The device of claim 7, wherein the voice input is additionally comprised of at least a second voice command including attribute information for controlling at least one other device.

9. The device of claim 7, wherein the voice recognition unit is further configured to compare the identified attribute information of the device against a list of device attributes that are available for voice command control, and recognize the first voice command as being intended for the device when the attribute information of the device is identified as one of the device attributes that are available for voice command control.

10. The device of claim 9, wherein the device attributes that are available for voice command control include at least one of a display adjusting feature, volume adjusting feature, data transmission feature, data storage feature and internet connection feature.

11. The device of claim 7, wherein the voice recognition unit is further configured to compare the identified attribute information of the device against a list of preset voice commands that are stored on a storage unit of the device, and recognize the first voice command as being intended for the device when the attribute information of the device is identified as one of the preset voice commands that are included in the list of preset voice commands.

12. The device of claim 7, wherein the voice recognition unit is further configured to compare the attribute information of the device against a list of attributes of the device that are currently being utilized by an application running on the device, and recognize the first voice command as being intended for the device when the attribute information of the device is identified as one of the device attributes that are currently being utilized by an application running on the device.

13. A method of recognizing a voice command by a device, the method comprising:
receiving a voice input including at least a first voice command and a second voice command;
processing the voice input by a voice recognition unit, and identifying the first voice command as including attribute information corresponding to the device and also identifying the second voice command as including attribute information that does not correspond to the device;
recognizing the first voice command as being intended for the device based on at least the attribute information of the device identified from the first voice command, and
controlling the device according to the recognized first voice command.

14. The method of claim 13, wherein the device is connected to a local network that includes at least a second voice recognition capable device.

15. The method of claim 13, further comprising:
transmitting information to the second voice recognition capable device identifying the device has been controlled according to the first voice command, and
displaying information identifying the device has been controlled according to the first voice command.

16. The method of claim 13, further comprising:
transmitting information to a second voice recognition capable device identifying the device has not been controlled according to the second voice command.

17. The method of claim 13, further comprising:
receiving information from a second voice recognition capable device identifying the second voice recognition capable device has been controlled according to the second voice command, and
displaying information identifying the second voice recognition capable device has been controlled according to the second voice command.

18. The method of claim 17, further comprising:
displaying information identifying the device has been controlled according to the first voice command.

19. The method of claim 13, further comprising:
displaying information identifying the device has been controlled according to the first voice command.
